(19) United States
(12) Patent Application Publication
(10) Pub. No.: US 2006/0055669 A1
(43) Pub. Date: Mar. 16, 2006

(54) Fluent user interface for text entry on touch-sensitive display

(76) Inventor: Mita Das, Cupertino, CA (US)

Correspondence Address: Dr. Mita Das, 10640 Morengo Dr, Cupertino, CA, 95014, US

(21) Appl. No.: 11/222,091

(22) Filed: Sep. 7, 2005

Related U.S. Application Data
(60) Provisional application No. 60/609,295, filed on Sep. 13, 2004.

(51) Int. Cl. G09G 5/00

(52) U.S. Cl. 345/156

(57) ABSTRACT

A user interface method and apparatus for an electronic device operates by detecting a stroke (20) of a touch sensitive display (10) forming a part of the electronic device. The stroke is interpreted by the user interface method (73) as a sequence of commands where each command is associated to one edge traversed by the stroke, and possibly to the direction and to the speed at which the input device crossed the edge. The touch sensitive display (10) can be shared between the user interface method and any other application. If a stroke does not traverse any edges or is identified by other means as irrelevant for the user interface method, it is translated into an application function.

### CROSS-REFERENCE TO RELATED APPLICATIONS

This application claims the benefit of provisional patent application Ser. No. 60609295 filed Sep. 13, 2004, by the present inventor.

### FEDERALLY SPONSORED RESEARCH:

Not Applicable

### SEQUENCE LISTING OR PROGRAM:

Not Applicable

### BACKGROUND OF THE INVENTION

1. Field of Invention

This invention relates generally to the field of human interfaces for electronic devices. Specifically, this invention relates to a text entry method for a touch sensitive medium such as a touch sensitive display. It describes a user interface method and apparatus for an electronic device, which operates by detecting a stroke of a touch sensitive display forming a part of the electronic device. The stroke is interpreted by the user interface method as a sequence of commands where each command is associated to one edge traversed by the stroke, and possibly to the direction and to the speed at which the input device crossed the edge. The touch sensitive display can be shared between the user interface method and any other application. If a stroke does not traverse any edges or is identified by other means as irrelevant for the user interface method, it is translated into an application function. This method features (i) a high throughput and accuracy, (ii) a low footprint, (iii) a text entry area that is possibly always active and sharing the display with any other application, (iv) a scalability to very small devices.

2. Prior Art

Many small handheld devices (personal device appliances or PDAs, cellular phones) offer more and more applications requiring text input (instant messaging, email, web-form filling, etc.). Text input is recognized today as the major bottleneck for the enhancement of services on small devices.

The following qualities are essential for a text input method on a handheld device:
1. easy to learn
2. fast, fluent and accurate
3. does not take away too much of the display
4. consistent throughout all applications.

Additionally, it is desired that the text input method on a handheld device
5. does not rely heavily on visual feedback (expert user can perform blind dialing)
6. can be operated with finger (for example the thumb, thus allowing to hold the device and write with the same hand).

On a handheld device a touch sensitive area on the display is commonly used as the only or primary input interface: for text input as well as for mouse-like actions such as navigation, selection, scrolling. Sharing efficiently a single input tool (stylus or finger) and a small display for both the application and the text input method is an issue. A large variety of solutions for text input on a touch sensitive display have been proposed so far:

Soft keyboards: Their layout can be either traditional (QWERTY) or optimized for fast stylus input. They usually occupy a dedicated area of the display; the small size of the keys does not allow finger input. Techniques involved in the design of keyboards optimized for stylus are described by I. S. MacKenzie and S. X. Zhang in The design and evaluation of a high-performance soft keyboard, Proceedings of CHI'99: ACM Conference on Human Factors in Computing Systems, pp 25-31. Examples of products working along these principles are the FITALY keyboard by Textware Solutions (see www.fitaly.com) or TapType by Linkesoft for Palm Pilot (see www.linkesoft.com/taptype).

Predictive entry methods: A language model (dictionary or n-grams) is used to ease the text input process either (i) by reducing the number of actions needed to enter a word (e.g. see U.S. patent 2002/0049795A1); (ii) by dynamically highlighting or placing close to the input tool the actions corresponding to entering the most likely next characters (e.g. www.inference.phy.cam.ac.uk/dasher/); or (iii) by reducing the number of keys needed to represent the entire alphabet. In the latter case, several characters are associated to each key and the language model is used to disambiguate an input sequence of keys and convert it into a sequence of characters (e.g. see U.S. Pat. No. 5,952,942 and U.S. Pat. No. 6,286,064 for methods primarily designed for phone keypads, or see www.tengo.com for a method developed specifically for a handheld device with a touch sensitive surface).

Handwriting recognition: A whole range of handwriting systems exists on handheld devices, recognizing either single stroke simplified characters (e.g. Unistroke, Graffiti, or TealScript), natural isolated characters (e.g. QuickPrint, Jot), or full cursive words or paragraphs (e.g. Calligrapher, Transcriber). These input techniques are usually all operated with a stylus.

Hierarchical menus: A hierarchy of menus is displayed on top of the working area. The root menu appears whenever the pointing tool touches the display, and a submenu is unfolded when the pointing tool moves into the associated pie of the current menu. Submenus are unfolded in this manner until the leaves, which correspond to the real menu items, for example to text input commands (T-Cube, described in G. Kurtenbach and W. Buxton, The limits of expert performance using hierarchic marking menus, Conference proceedings on Human factors in computing systems, pages 482-487. ACM, 1993). This approach is quite slow, as each symbol input requires a complex stroke.

Swish, flick, drag or slide: Another way to cope with small size while designing ‘keyboard-like’ text input methods is to associate more than one symbol with each key and to input actions that are richer than tap to discriminate between each symbol. Several solutions allow the input tool to perform small movement on each key. These movements are kept as simple as possible, i.e. are straight and short and their directions are associated with the appropriate symbols.

These approaches emerged from the need to enter alphanumerical symbols from the numerical keypad of a phone. U.S. Pat. No. 6,104,317 proposed to use stylus movements named Flicks on a touch sensitive display representing the standard phone keypad, to discriminate between “a”, “b” or “c” when the key “2” is activated.

MessageEase by ExIdeas (www.exideas.com, U.S. Pat. No. 6,847,706) is a text input method where the alphabet is mapped on a 3×3 grid. The nine most common letters are mapped to taps on each one of the nine zones of the grid, the remaining letters are associated to moves (or drags or slides) initiated in one zone and directed either upward, downward, left, or right.

A related idea known as Sequential Stroke Keyboard is proposed in U.S. Pat. No. 6,378,234 B1 for entering text on a mechanical keypad of a reduced set of keys (e.g. phone). For each horizontal or vertical neighboring pairs of keys, two symbols are associated with fast sequential activations of the two keys in both orders. In contrast to MessageEase, there is no optimization of the mapping in this case: “a” and “b” are associated to the pair “1-2”, “c” and “d” to the pair “2-3”, etc.

These methods allow for fast and robust text input. On a PDA or a phone form factor, whenever the keypad can occupy the entire real estate of touch sensitive display, keys can be made large enough to be finger operated. Alternatively, the keypad can be scaled down to even smaller form factors, such as a wristwatch.

Unistroke words: More fluent text input methods that do not require lifting the pen between each character present a strong appeal, in the same way that cursive or mixed (i.e. print/cursive) handwriting is preferred over pure print (e.g. isolated character input) as it allows input in a more continuous way. Several solutions exist that allow entering a fill word in a single stroke:

QuikWriting (K. Perlin, Quikwriting: continuous stylus-based text entry, Proceedings of the 11th annual ACM symposium on User interface software and technology, pages 215-216, ACM, 1998) is cumbersome and slow.

Cirrin (J. Mankoff and G. D. Abowd, Cirrin: a word-level unistroke keyboard for pen input, Proceedings of the 11th annual ACM symposium on User interface software and technology, pages 213-214, ACM, 1998) organizes the characters of the alphabet in a dial it is not scalable to small sizes devices and requires high precision of the input tool.

SHARK (Text input for future computing devices (SHARK shorthand and ATOMIK, http://www.almaden.ibm.com/u/zhai/topics/virtualkeyboard.htm) presents a touch keyboard with one key per character arranged in an optimal way. The stylus can navigate from one key to another without need to leave the touch-sensitive device between characters. A language model (dictionary+n-grams) is used to disambiguate the strokes, and idiosyncrasies of each writer are learned through a training process. This approach is promising, but its algorithmic complexity is in the same order of magnitude that cursive handwriting recognition.

Thus, in summary, relevant prior art of U.S. patents and patent application publications include: 2002/0049795A1—Computer assisted Text Input System, Freeman. U.S. Pat. No. 5,952,942—Method and Device for Input of Text Messages from a Keypad, Balakrishnan et al. U.S. Pat. No. 6,286,064—Reduced Keyboard and Method for simultaneous Ambiguous and Unambiguous Input, King et al. U.S. Pat. No. 6,104,317—Data Entry Device and Method, Panagrossi. U.S. Pat. No. 6,847,706—Method and Apparatus for Alphanumeric data entry using a Keypad, Bozorgui-Nesbat. U.S. Pat. No. 6,378,234 B1—Sequential Stroke Keyboard, Luo.

### OBJECTS AND ADVANTAGES

Many small handheld devices (personal device appliances or PDAs, cellular phones) offer more and more applications requiring text input (instant messaging, email, web-form filling, etc.). Text input is recognized today as the major bottleneck for the enhancement of services on small devices.

The advantages of the invention are given below:
1. It is simple, and allows fast text input.
2. An implementation with a highly accurate recognition of each text input action (i.e. edge crossing) is straightforward, unlike handwriting recognition, for example.
3. The number of keys is highly reduced, which makes the input method scalable to very small devices, e.g., wristwatch.
4. The layout is static and thus does not rely on visual feedback so that an expert user can do blind typing.
5. Can be operated with finger (for example the thumb, thus allowing to hold the device and write with the same hand).

### SUMMARY OF THE INVENTION

A first principal of the present invention is the provision of an electronic device equipped with a “touch sensitive medium” such as a touch sensitive display or a touch sensitive input area, capable of detecting and localizing a touch or pressure point from a “touching tool” such as a stylus or a finger, and capable of capturing the change in the localization of this touch point until a release point.

A second principal of the present invention is the provision for generation of text of language on the electronic device by means of the touch sensitive medium. This text generation method must be intuitive, easy to learn, efficient, fast, and must require only a small area of the touch sensitive medium.

The present invention proposes to have a set of lines or edges drawn on the touch sensitive medium and to associate to each line or edge one text editing command. A text editing command is issued by the text input method of the present invent every time the touching tool is moved on the touch sensitive medium and crosses the edge or line this text editing command is associated to.

Alternatively, two text editing commands can be associated to each line or edge on the touch sensitive medium, with the convention that one text editing command is generated when the touching tool crosses the line or edge in one direction, while the second text editing command is generated when the touching tool crosses the line or edge in the other direction.

In addition to the crossing direction of the line or edge, the speed at which the touching tool crosses a particular line or edge can be recorded and used to generate a higher diversity of text editing commands using the same touch sensitive medium. For example, the two text editing commands corresponding to entering the lower case and entering the upper case form of a same symbol can be associated with a fast and slow crossing by the touching tool of the same edge or line in the same direction.

The fluency of the text input method disclosed in this invention is related to the observation that a single “stroke” from the touching tool can be crossing several lines or edges in a precise order and direction.

It is also part of the present invention to optimize (i) the layout of the set of lines or edges, and (ii) the association of the line or edge to text editing commands in such way that most common words of the targeted language can be entered with a minimum number of strokes and with strokes as simple as possible.

### DRAWINGS—FIGURES

FIG. 1 illustrates two exemplary layouts consistent with certain embodiments of the present invention.

FIG. 2 illustrates a stroke drawn on an exemplary layout consistent with certain embodiments of the present invention.

FIG. 3 exemplifies possible associations of text editing commands to components of layout consistent with certain embodiments of the present invention.

FIG. 4 highlights the semantic difference between a stroke consistent with the present invention, and a stroke consistent with some related previous inventions.

FIG. 5 illustrates the fluent text input concept by showing two strokes drawn on an exemplary layout and corresponding to sequences of several characters.

FIG. 6 illustrates a blind version of a layout consistent with the embodiments of the present invention.

FIG. 7 illustrates a block of an exemplary electronic device consistent with the embodiments of the present invention.

FIG. 8 illustrates a flow chart depicting operations of the processor of the device of FIG. 5.

### DETAILED DESCRIPTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding elements in the several views of the drawings.

The terms “text”, “symbol” and “character” as used herein is intended to include both alphanumeric characters and common punctuation characters along with any other characters that might be desirably entered via a single stroke of a keyboard (e.g., +, /, †, |, #, @, ˜, etc.). Additionally, these terms are to be considered both singular and plural, in that a reference to entering a character can include making a single entry that contains multiple characters (e.g., commonly used combinations of characters such as “QU” or “SH” may be handled in some data entry scenarios the same as if the combinations were a single character). Moreover, the terms “text”, “symbol” or “character” may take on equivalent meanings for character sets other than those commonly used in connection with the English language.

The term “text editing command”, as used herein, is defined as either entering a text, symbol or character, or issuing any editing command (e.g. SPACE, TAB, NEWLINE, BACKSPACE, DELETE, etc.).

The terms “touch sensitive area” and “touching tool”, as used herein, are defined as a pair of devices, one area 10 and on tool (possibly a finger) with the following functionalities. (i) The tool can be in two different states with respect to the area that are named “touching” and “non-touching”. The term “touching”, as used herein, represents either a physical contact between the tool and the area, or any other form of two state relationships. For example, if the tool is a laser beam and the area is a screen, the tool touches the area whenever the beam is on and pointing into the screen. (ii) Whenever the tool touches the area, an instantaneous position of the touching point can be calculated in a system of coordinates relative to the area. Unlike a mouse of a standard desktop computer, it is not required that a position is inferred when the tool does not touch the area.

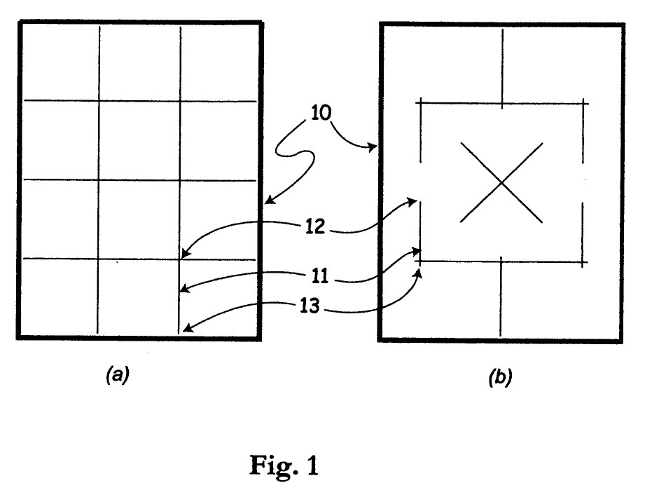

The terms “edge” or “line” 11, as used herein and as illustrated in FIG. 1, are defined as static frontiers on the touch sensitive area, with two extreme locations 12 and 13, straight or curved, visible, partly visible, or total hidden.

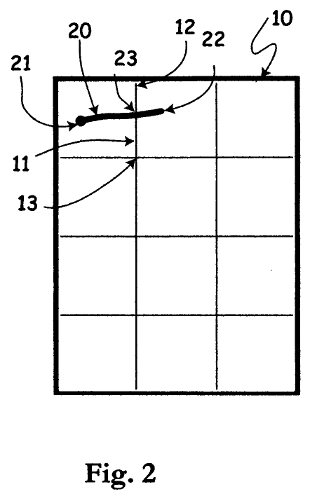

The term “stroke” 20, as used herein, and as illustrated in FIG. 2, is an oriented sequence of touching points of the touching tool on the touch sensitive area, which is built through time, at a given speed, without interruptions i.e. so that the touching tool touches the touch sensitive area all along the stroke. The first point of the stroke is the “pen down point” 21. This is the point where the state of the tool changes from non-touching to touching the touch sensitive area. The last point of the stroke is the “pen up point” 22. This is the point where the state of the tool changes from touching to non-touching the sensitive area.

A stroke is said to “cross” an edge on the touch sensitive area, if there are two consecutive touching points in the sequence defining the stroke that are close to the edge, and such that one is on one side of the edge, and the other one is on the other side of the edge. As illustrated in FIG. 2, the “crossing direction” along which a stroke 20 crosses an edge 11 bounded by locations 12 and 13 is of two kinds, depending whether 12 or 13 lays on the portion of the edge that is at the left of the crossing point 23 when viewed in the direction of the stroke.

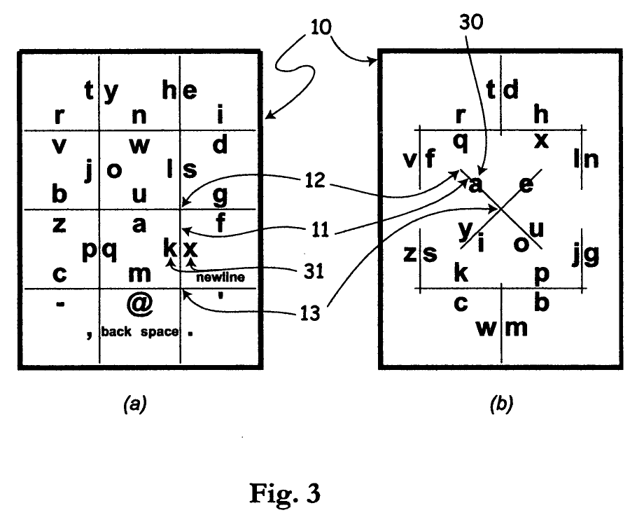

The principle of the invention consists in associating text-editing commands to edges. The two examples of layouts of edges of FIG. 1 are reported in FIG. 3, along with text editing commands associated to edges. In a simple form, a text editing command is associated to an edge. For example the command 30, “issuing character ‘a’”, is associated to edge 11 in FIG. 3(b) that has points 12 and 13 as extreme points. Whenever a stroke crosses edge 11 an ‘a’ is sent to the application currently active on the device.

In another embodiment consistent with the present invention, different text editing commands are associated to each crossing direction of some edge. For example, commands 31 “issuing ‘k’” is associated to the left-to-right crossing direction of edge 11 in FIG. 3(a) that has points 12 and 13 as extreme points, while the right-to-left crossing direction for the same edge 11 in FIG. 3(a) corresponds to “issuing ‘x’”.

In yet another embodiment consistent with the present invention, the equipment (touch sensitive area+touching tool) offers the possibility of measuting the speed of the touching tool on the area when in a touching state. Different text editing commands can be associated to a same edge and crossing direction, but to different speed levels. For example, the text editing command “issuing ‘A’” can be associated to the same edge and crossing direction than “issuing ‘a’” but to a lower crossing speed.

In yet another embodiment consistent with the present invention, the equipment (touch sensitive area+touching tool) offers the possibility of measuring a time lap during which the touching tool stays in a touching state without motion either at the beginning of the stroke or at the end of the stroke. Different text editing commands can be associated to a same edge, crossing direction and crossing speed, but to different time lap of motionless touch. For example, a standard keyboard usually offers the behavior that when the corresponding key is held down for some time, the last command is repeated. This behavior, particularly useful for commands such as “issuing a dot” or “backspace”, can be replicated by our invention, where the last command is repeated whenever the touching tool keep touching the touch sensitive area without motion for some time at the end of a stroke.

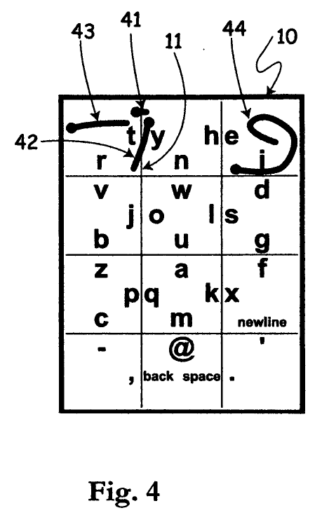

Even though the form of the layout in FIG. 3(a) may appear similar to the ones related to prior art (e.g. U.S. Pat. Nos. 6,104,317, and 2002/0136371 A1), the concept of associating text editing command to edges, and eventually crossing direction and crossing speed is different than in prior art, where a text editing command is associated to a cell (or key) containing the pen-down point of a stroke and to the general direction of the stroke. FIG. 4 exemplifies this difference. In this particular example, stroke 41 issues character ‘t’, both with the present invention, as a stroke crossing edge 11 from left to right, as well as with the prior art, as a rightward stroke initiated in the upper-left cell of the touch sensitive area 10. Stroke 42 however issues character ‘y’ with the present invention, as a stroke crossing edge 11 from right to left; while it will issue character ‘n’ with prior art, as a generally downward stroke originated in the middle upper cell. Strokes 43 and 44 do not issue any text editing command with the present invention in this particular example, as they do not cross any edge; while stroke 43 would again issue character ‘t’ with the prior art.

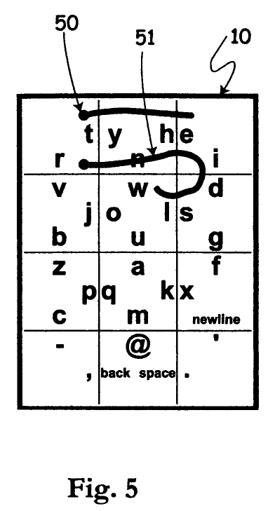

This new concept brings a significant advantage in the fluency of the writing as a single stroke can cross consecutively more than one edge. By associating the text editing commands to the edges and crossing direction in a smart way, the most common pairs of characters in the targeted language can be entered in a single stroke. In English ‘th’ is the most common pair of character and in the example of FIG. 5; stroke 50 corresponds to issuing the sequence of characters ‘t’, ‘h’. Similarly, many short words can be entered in a single stroke, and most word can be entered in a small amount of strokes. Stroke 51 in FIG. 5 corresponds to entering the word ‘this’.

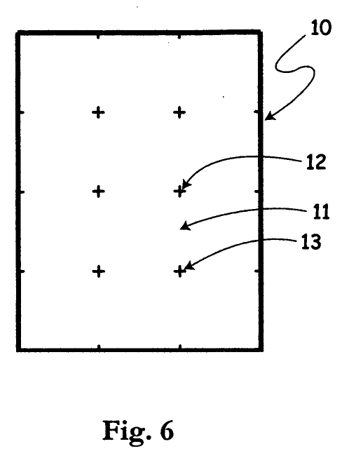

The text input user interface for small hand-held devices has always been a data entry bottleneck, and the problem worsens as such devices get smaller and increasingly powerful. Certain embodiments consistent with the present invention, relate to a method and apparatus for permitting the data entry area of a touch sensitive area to be shared with an application's display functions (e.g., prompts, icons, data entry box, windows, menus, and other visual objects, etc.) without conflict. If the text input area is shared with areas that display the application, output conflicts may occur as the information displayed by the application and the layout of the text input method overlay each other; and also input conflicts may occur wherein the device of interest may receive input that could be interpreted either as text entry or application commands. Certain embodiments of the present seek to resolve such conflicts. The text entry display can be made almost invisible for experimented users as depicted in FIG. 6: edge 11 is represented by its extreme points 12 and 13 only, and the mapping between edges and text editing commands is supposed to be known by the experimented user. The input conflicts are resolved by segregating input strokes between text editing strokes, and other touching tools actions, such as tap, that are intended for the application.

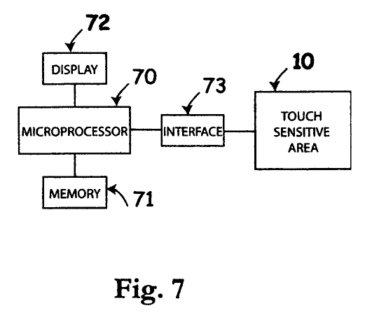

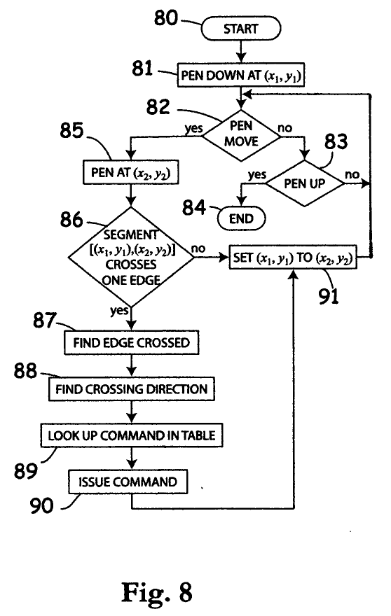

The data entry device is not complex in terms of apparatus and is illustrated in FIG. 7. It comprises a touch sensitive area 10 connected to an interface 73, to which it communicates the state of the touching tool (touching or non-touching) as well as the location of the touching point in the case of a touching state. The interface is connected to a microprocessor 70. The processor 70 may be a general-purpose processor or a microprocessor or a dedicate control device, such as an application specific integrated circuit. The processor 70 is coupled to a memory 71 and a display 72 and it performs the process illustrated in FIG. 8.

The process starts at 80 when the touching tool touches the touch sensitive area. This action causes the location of the touching tool to be recorded 81. If a no motion is detected 82, the status of the touching tool is checked again 83. If a pen-up is detected, the stroke has ended and this marks the end 84 of this process. If no pen-up is detected, the process loops until a pen-up 83 or a motion 82 is detected. Whenever a motion is detected, the new location of the touching tool is recorded 85 and compared with the previous location 86 to find out whether an edge was just crossed. If not, the latest location is saved in the primary location memory 91 and the process waits for the next move or pen-up. Whenever it is found 86 that an edge has been crossed, the edge 87 and the crossing direction 88 are identified and the corresponding text editing command 89 is issued 90. The latest location is saved in the primary location memory 91 and the process waits for the next move or pen-up.

It is beyond the scope of this discussion to define the best layout of a text entry grid for this text input. However, it is noted that there is probably no single layout that would be preferred by all users. Some users are already familiar with the mapping on phone keypads (2abc, 3def, etc.) while others are not. Some users don't mind a learning phase if it pays off later in terms of speed and they would enjoy an optimized layout allowing many common pairs or triplets of characters to be entered in a single stroke, while others want the layout to be intuitive and easy to memorize. Others may wish to conform to an alphabet based, QWERTY, style, or other layout. Other layouts may be based upon geometries rather than a grid of cells. Each of these potential realizations is contemplated, as is an implementation wherein the user is able to select a layout from a plurality of different layouts.

Alphabets with large numbers of symbols, as well as caps and lower case characters, can potentially be addressed in several different ways. For example, without intending to impose any limitation, there can be more than one layout (for lower case and upper case characters, for digits, for punctuation and special symbols), and switching from one to the other can be accomplished either by a special stroke. In other embodiments, a single modeless layout containing all possible text editing commands and crossed edge, crossing direction, crossing speed, and lap of motionless touch are all used together to provide enough combinations for all text editing commands.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors, which are equivalents to the invention as described. Similarly, general purpose computers, microprocessor based computers, micro-controllers, optical computers, analog computers, programmable logic circuits, dedicated processors and/or dedicated hard wired logic may be used to construct alternative equivalent embodiments of the present invention.

The present invention, as described in embodiments herein, has been described as being implemented using a programmed processor executing programming instructions that are broadly described above in flow chart form that can be stored on any suitable computer readable storage medium (e.g., disc storage, optical storage, semiconductor storage, etc.) or transmitted over any suitable electronic communication medium. However, those skilled in the art will appreciate that the processes described above can be implemented in any number of variations and in many suitable programming languages without departing from the present invention. For example, the order of certain operations carried out can often be varied, additional operations can be added or operations can be deleted without departing from the invention. Error trapping can be added and/or enhanced and variations can be made in user interface, text entry grid, and information presentation without departing from the present invention.

While the invention has been described in conjunction with specific embodiments, it is evident that many alternatives, modifications, permutations and variations will become apparent to those of ordinary skill in the art in light of the foregoing description.

I claim:

1. A method for entering in an electronic device an arbitrary sequence of commands from a determined plurality of commands comprising:
(a) a touch sensitive medium serving as input interface of said electronic device
(b) a touching device operating on said touch sensitive medium selected from the group comprising stylus and pen and finger
(c) an input area on said touch sensitive medium
(d) a plurality of edges drawn within said text input area
(e) an association rule relating edges of said plurality of edges to commands of said plurality of commands
and proceeding by:
(f) detecting a stroke traced by a continuous motion of said touching device onto said input area
(g) determining the sequence of edges of said plurality of edges that are traversed by said stroke
(h) entering the corresponding sequence of commands resulting from applying said association rule sequentially to each edge in said sequence of edges.

2. The method for entering a sequence of commands in an electronic device according to claim 1 wherein said plurality of commands is a plurality of text editing commands selected from a group comprising typing a symbol from a determined plurality of symbols.

3. The method for entering a sequence of commands in an electronic device according to claim 1 wherein said touch sensitive medium captures the two directions along which said touching device traverses each edge of said plurality of edges and wherein a command from said plurality of commands is associated by said association rule to each edge and to each one of the two directions of traversal.

4. The method for entering a sequence of commands in an electronic device according to claim 1 wherein said touch sensitive medium captures a plurality of speed levels at which said touching device traverses each edge of said plurality of edges and a command from said plurality of commands is associated by said association rule to each edge and to each speed level of traversal of said plurality of speed levels.

5. The method for entering a sequence of commands in an electronic device according to claim 4 wherein said speed levels are automatically adjusted to the user of the method.

6. The method for entering a sequence of commands in an electronic device according to claim 1 wherein
(a) the placement of said plurality of edges
(b) said association rule relating edges to commands
are determined in a way that sequences of commands that are often used consecutively can be entered by said touching device in a single stroke.

7. The method for entering a sequence of commands in an electronic device according to claim 3 wherein a pair of commands of said plurality of commands that are logically paired are associated by said association rule to each one of the two directions of traversal of a same edge.

8. The method for entering a sequence of commands in an electronic device according to claim 4 wherein a group of commands of said plurality of commands that are logically related are associated by said association rule to each one of said speed level of traversal of a same edge.

9. The method for entering a sequence of commands in an electronic device according to claim 1 wherein said plurality of edges are displayed in said input area in a plurality of display modes selected from the group comprising
(a) a mode where each edge and each associated command is displayed prominently
(b) a mode where each edge is displayed only partly.

10. The method for entering a sequence of commands in an electronic device according to claim 1 wherein said input area is shared with an application other than said method for entering a sequence of commands and wherein each said stroke is determined to belong to said method for entering a sequence of commands if it traverses an edge of said plurality of edges and to belong to said other application otherwise.

11. The method for entering a sequence of text editing commands according to claim 2 wherein a dictionary in the form of a list of possible sequences of symbols from said plurality of symbols is used for improving user experience using techniques selected from the group comprising automatic completion of a partially entered sequence of commands and automatic correction of an entered sequence of commands.
